(19) United States
(12) Patent Application Publication
(10) Pub. No.: US 2015/0118578 A1
(43) Pub. Date: Apr. 30, 2015

(54) CATHODE FOR LITHIUM SULFUR BATTERY AND METHOD FOR PREPARING THEREOF

(71) Applicant: Hyundai Motor Company, Seoul (KR)

(72) Inventors: Won Keun Kim, Suwon (KR); Yoon Ji Lee, Bucheon (KR); Jun Ki Rhee, Namyangju (KR)

(73) Assignee: Hyundai Motor Company, Seoul (KR)

(21) Appl. No.: 14/145,159

(22) Filed: Dec. 31, 2013

(30) Foreign Application Priority Data
Oct. 31, 2013 (KR) 10-2013-0130784

(51) Int. Cl. H01M 4/58; H01M 10/052; H01M 10/0569

(52) U.S. Cl. CPC H01M 4/58; H01M 10/0569; H01M 10/052
USPC 429/335; 429/341; 429/337

(57) ABSTRACT

Disclosed is a cathode for a lithium sulfur battery comprising a sulfur-containing active material, an electrolyte in which a lithium salt is dissolved in an ether-based solvent, and an additional liquid active material in the form of Li₂Sₓ (0<x≦9) dissolved in the electrolyte, and a lithium sulfur battery using the same. The lithium sulfur battery of the present invention has a loading amount of cathode sulfur that is increased to at least about 13.5 mg/cm² and a structural energy density that is increased from about 265 Wh/kg to at least about 355 Wh/kg as compared with a conventional battery.

### CROSS-REFERENCE TO RELATED APPLICATIONS

This application claims priority to and the benefit of Korean Patent Application No. 10-2013-0130784 filed in the Korean Intellectual Property Office on Oct. 31, 2013, the entire contents of which are incorporated herein by reference.

### TECHNICAL FIELD

The present invention relates to a cathode for a lithium sulfur battery and a method for preparing thereof, and more particularly, to a lithium sulfur battery having a maximized energy density per weight by using an electrolyte in which an additional active material is dissolved.

### BACKGROUND ART

Along with advancements in technologies for portable electronic devices, there has been a growing demand for a lightweight and high-capacity battery. As a secondary battery to satisfy the demand, a lithium sulfur battery using a sulfur-based material as a cathode active material has been developed.

The lithium sulfur battery is a secondary battery that uses (1) a sulfur-based material having an S—S bond (Sulfur-Sulfur bond) as a cathode active material and (2) a carbon-based material, in which intercalation or deintercalation of alkali metal such as lithium or a metal ion such as a lithium ion occurs, as an anode active material. During a reduction reaction (at the time of electrical discharge), the S—S bond breaks and an oxidation number of S is decreased. During an oxidation reaction (at the time of electrical charge), the oxidation number of S is increased and the S—S bond is formed again. By using such an oxidation-reduction reaction, the lithium sulfur battery generates and stores electrical energy.

If lithium metal is used as an anode active material, the lithium sulfur battery has an energy density of 3830 mAh/g, and if sulfur (S₈) is used as a cathode active material, the lithium sulfur battery has an energy density of 1675 mAh/g. Therefore, the lithium sulfur battery is the most promising battery in terms of energy density among batteries developed so far. Further, the lithium sulfur battery has an advantage in that the sulfur-based material used as a cathode active material is an inexpensive and eco-friendly material.

However, a lithium sulfur battery system has limitations on commercialization. If sulfur is used as an active material, sulfur availability (meaning the amount of sulfur participating in an electrochemical oxidation-reduction reaction) in a battery with respect to an amount of sulfur input is low. Unlike the theoretical amount, the battery actually has a very low battery capacity. Further, at the time of the oxidation-reduction reaction, the sulfur leaks into the electrolyte, thereby decreasing battery life. If an appropriate electrolyte is not selected, lithium sulfide (Li₂S) as a sulfur reducing substance is precipitated and the sulfur cannot thereafter participate in the electrochemical reaction. Furthermore, when a lithium metal having very high reactivity is used as an anode active material, unless an appropriate electrolyte which does not react with the lithium metal is selected, dendrite of the lithium metal is generated at the time of electrical charge/discharge. This may cause deterioration in cycle life characteristics.

Many attempts have been made to solve a problem of lower than theoretical charge/discharge capacity. For example, structure which does not allow generation of dendrite has been manufactured, and an electrolyte having a composition which does not cause a leak of sulfur has been made. However, there is a limit in expressing a charge/discharge capacity as stable and as high as an actual demand level.

In connection with a lithium sulfur battery, particularly the configuration of the cathode, there are conventional designs, such as those described in the following Documents.

EP Patent No. 1,149,428 describes an electric current producing cell comprising a cathode including a sulfur-containing cathode active material, an anode, a solid porous separator, and a non-aqueous electrolyte formed of a lithium salt such as Li₂Sₓ (x is an integer of 1 to 20) or the like and an ethers solvent such as dimethyl ether or the like.

WO Publication No. 2001-0035475 describes a primary electrochemical cell comprising a lithium anode, a cathode formed of a sulfur-containing material, a voltage rise reactive element, and a non-aqueous electrolyte formed of a non-aqueous electrolyte solvent such as ether or the like and a lithium salt such as Li₂Sₓ (x is an integer of 1 to 20).

Korean Patent Application Laid-Open No. 2007-0085575 describes an electrolyte for a lithium sulfur battery comprising one or more electrolyte salts dissolved in a neutral solvent such as a diglyme(2-methoxyethylic ether), 1,3-dioxolane, or the like and an additive such as Li₂Sn or the like. Also described is a lithium sulfur battery comprised of a negative electrode including a lithium-containing material and a positive electrode including a sulfur-containing material.

C. Barchasz et. al., Anal. Chem. 2012, 84, 3973 describes a product manufactured with Li₂Sₓ at a low concentration of 0.01 M. The operation/reaction mechanism of a lithium sulfur battery formed therewith is studied and the results of chromatography and UV absorption wavelength are analyzed.

### SUMMARY OF THE INVENTION

The present invention provides a lithium sulfur battery having a maximized energy density per weight. In particular, the lithium sulfur battery is provided with a maximum energy density by dissolving an additional active material in an electrolyte of the battery, rather than the conventional method of simply increasing a loading amount of sulfur as a cathode of the l battery.

According to one aspect, the present invention provides a cathode for lithium sulfur battery comprising a sulfur-containing active material, an electrolyte in which a lithium salt is dissolved in an ether-based solvent, and an additional liquid active material in the form of Li₂Sₓ (0<x≦9) dissolved in the electrolyte. According to another aspect, the present invention provides a lithium sulfur battery using the cathode described herein.

According to embodiments of the present invention, a lithium sulfur battery manufactured by using an electrolyte in which an additional active material is dissolved provides an improved loading amount of cathode sulfur. In particular, the loading amount is increased from 2 to 6 mg/cm² provided by a conventional battery to at least about 13.5 mg/cm².

The above loading amount is obtained by estimating conditions (weight, capacity, area, and the like) of each component of the battery to calculate an energy density and dividing a product of the capacity and voltage by a weight of a cell: (capacity*voltage)÷weight (wherein capacity*voltage provides units in the form of “Wh”).

With all other conditions being equal, when the capacity incrementally increases as a result of an increase in a sulfur loading amount, a structural energy density is increased from about 265 Wh/kg to about 355 Wh/kg.

Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 depicts use of an electrolyte replenisher and a carbon sheet as a conduction structure so as to maximize effects of the active material according to an embodiment of the present invention.

FIG. 2A graphically depicts the results of experiments determining voltage vs. capacity using a conventional cell in Case 1, and FIG. 2B graphically depicts the results of experiments determining voltage vs. capacity using a PS electrolyte-added cell in Case 1 according to an embodiment of the present invention.

FIG. 3 graphically depicts the results of experiments determining capacity vs. cycle using a PS electrolyte-added cell in Case 1 according to an embodiment of the present invention.

FIG. 4 graphically depicts the results of experiments determining voltage vs. capacity using a PS only cell in Case 2 according to an embodiment of the present invention.

FIG. 5 graphically depicts the results of experiments determining capacity vs. cycle using a PS electrolyte-added cell in Case 2 according to an embodiment of the present invention.

It should be understood that the appended drawings are not necessarily to scale, presenting a somewhat simplified representation of various preferred features illustrative of the basic principles of the invention.

In the figures, reference numbers refer to the same or equivalent parts of the present invention throughout the several figures of the drawing.

### DETAILED DESCRIPTION

The terms and words used in the specification and claims are not supposed to be construed in a conventional manner or on a dictionary basis, and the inventors are supposed to use the terms and words well matching with the technical concepts based on the principles that the concepts of the terms and words can be properly construed in order to describe the present invention in the best way.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention will be explained in detail with reference to Tables and the accompanying drawings.

While currently available electrolytes suggest using Li₂Sₓ as a candidate group for a lithium salt which is one of essential elements of an electrolyte, the present invention uses LiTFSI (Lithium-Bis-Trifluoromethanesulfonyl-Imide) as a lithium salt and adds the LiTFSI in the form of Li₂S₈ in an excessive amount to “additionally” dissolve an active material S in the electrolyte. Further, as a cathode of the present invention, an active material is dissolved in the electrolyte in a large or excessive amount. Thus, in order to electrochemically operate and express a capacity, a conduction structure having a large surface area is used in addition to a cathode plate. This conduction structure having a large surface area serves as a reaction site. According to preferred embodiments of the present invention, a carbon sheet is used as a conduction structure.

Difference Between Lithium Salt and Active Material in the Electrolyte

As mentioned above, the lithium salt is one of the essential elements of the electrolyte. Typically, the additional active material is dissolved in the electrolyte together with the lithium salt. In the present invention, a key point of the additional active material is to add S in a soluble form in the electrolyte. The soluble form of S in the electrolyte can be, for example, Li₂S₈.

Lithium in the lithium salt according to conventional methods does not serve as an active material but, rather, is used for ion transfer. On the other hand, the present invention uses an active material Li₂Sₓ containing S. Further, in order for Li₂Sₓ to be actually used as a lithium salt in an electrolyte, the salt needs to have excellent solubility and chemical stability. As such, Li₂Sₓ cannot be used alone as a lithium salt. In the present invention, a lithium salt for ion transfer and Li₂Sₓ as the additional active material are used together and, respectively, perform their individual functions in the electrolyte.

AS noted above, C. Barchasz et. al., Anal. Chem. 2012, 84, 3973, analyzes chromatography and UV absorption wavelength on a product manufactured with Li₂Sₓ at a low concentration of 0.01 M for analyzing an operation/reaction mechanism of a lithium sulfur battery. However, the present invention describes, for the first time, use of Li₂Sₓ having a very high concentration as an additional active material, resultant electrolytes and lithium salt, and an overall structure of a lithium sulfur battery formed therewith.

Composition of the Present Invention

The present invention provides a cathode for a lithium sulfur battery comprising a sulfur-containing active material, an electrolyte in which a lithium salt is dissolved in an ether-based solvent, and an additional liquid active material. According to preferred embodiments, the active material is in the form of Li₂Sₓ (0<x≦9) and is dissolved in the electrolyte.

Further, the present invention provides a cathode for lithium sulfur battery in which the additional liquid active material Li₂Sₓ (0<x≦9) in the electrolyte has a concentration of more than about 0 M to about 6 M or less. The ether-based solvent may suitably employ any ether-based solvents typically used in the lithium sulfur battery field. According to various embodiments, for example, the ether-based solvents are selected from the group consisting of dimethoxyethane, ethylene glycol dimethyl ether, sulfolane, dioxolane, dioxane, or mixtures thereof. Preferably, the ether-based solvent is TEGDME (Tetraethylene glycol dimethyl ether), DIOX (1,3 dioxolane), or a mixture thereof since these materials have an adequate viscosity for use as an electrolyte solvent and are appropriate for dissolution of Li₂Sₓ as an intermediate product. According to a preferred embodiment, similar amounts of TEGDME and DIOX are used together, such as a mixing ratio of about 1:1. For ion transfer in the electrolyte, as the lithium salt to be dissolved, LiPF₆, LiTF, LiTFSI, and LiClO₄ may suitably be used. According to a preferred embodiment, LiTFSI (Lithium-Bis-Trifluoromethanesulfonyl-Imide) is used since it is easily dissolved in an ether-based solvent and it is stable. According to a preferred embodiment, a concentration of the lithium salt in the electrolyte is about be 1 M.

The present invention further provides a lithium sulfur battery comprising a cathode using sulfur as an active material, a separator, and an anode containing lithium. In particular, a conduction structure is interposed between the cathode (in which the additional liquid active material Li₂Sₓ (0<x≦9) is dissolved in the electrolyte at concentration of about 0 M to about 6 M) and the separator, and the conduction structure is a porous structure. Preferably, the porous structure is a carbon sheet in order to provide an increased reaction site for sulfur. In particular, a carbon sheet is preferably used because a carbon sheet has a large surface area and an excellent electronic conductivity.

Hereinafter, the present invention will be explained in detail with reference to Examples. The Examples are provided only for illustration of the present invention. It will be apparent to one of ordinary skill in the art that and the scope of the present invention cannot be construed as being limited to the Examples.

### EXAMPLES

### Preparation Example 1

At the initial stage in a lithium sulfur battery, a cathode was S (S₈) and an anode was lithium metal (Li). When electric discharge was started, the S₈ received the Li and produced lithium polysulfide Li₂S₈. The Li₂S₈ participated in a reaction while being dissolved in an electrolyte. At the end of the electric discharge, Li₂S remained at the cathode. A saturation solubility of the Li₂S₈ with respect to the electrolyte (1M LiTFSI in TEGDME) was about 6 M.

First of all, a Li₂S₈ (additional active material) liquid was prepared according to a stoichiometric ratio at 6 M in a reaction formula [42S+6Li₂S=6Li₂S₈]. A solvent was 1M LiTFSI in TEGDME, and stirring was carried out at 50° C. for 12 hours. The electrolyte in which the Li₂S₈ was dissolved will be referred to as a “PS electrolyte” below.

Assuming that the Li₂S₈ liquid is added in an amount of 10 μm to the electrolyte (carried out in a small cell experiment for the evaluation of material characteristics), in terms of an amount of a cathode active material, a loading amount of cathode sulfur was increased from 5 mg/cm² to 13.5 mg/cm².

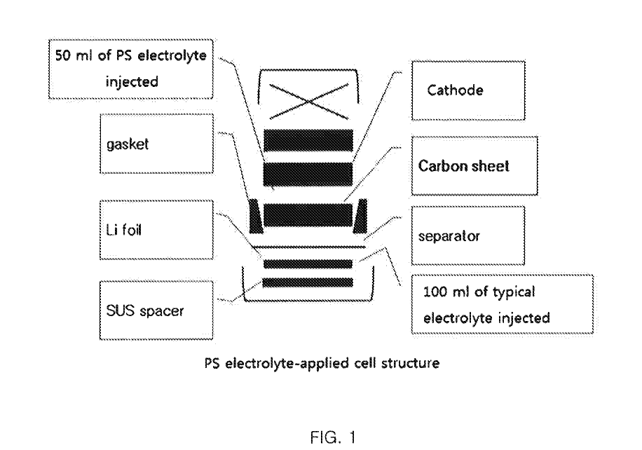

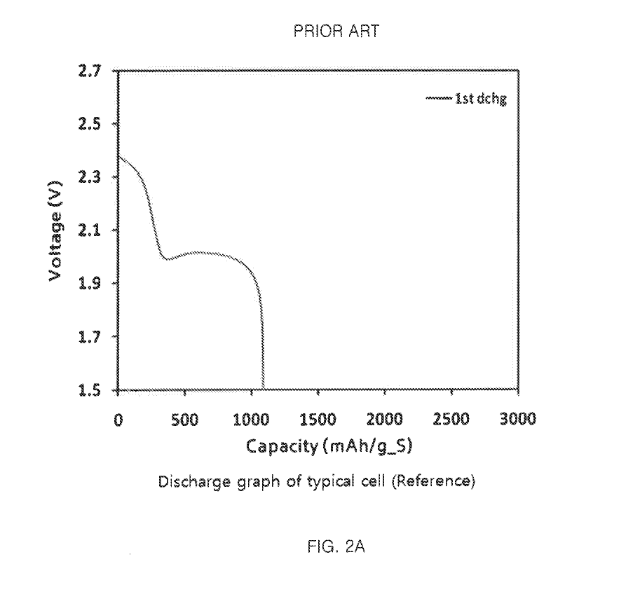

It could be seen from the above result that the active material is present in the cell in a great amount, and, thus, when an electrolyte replenisher and a carbon sheet as a conduction structure are used, effects of the active material can be maximized (refer to FIG. 1).

### Preparation Example 2

0.25 M, 1 M, and 3 M PS (Li₂S₈) electrolytes were prepared.

10 ml of 1M LiTFSI in TEGDME/DIOX (1/1) was mixed with a mixture of Li₂S (45.95 g/mol) and S (32.06 g/mol) powders mixed in a 0.2 M LiNO₃ solution to provide a stoichiometric composition. The stoichiometric composition was based on a reaction formula (7xS+xLi₂S=xLi₂S₈). After stirring was carried out at 50° C. for 12 hours, as for the 3 M PS electrolyte, the powders were not dissolved. It was determined that a solubility was low since DIOX was mixed in the solvent and LiTFSI and LiNO₃ salt were already dissolved in the electrolyte.

Cell Assembly

Case 1. (PS Electrolyte Added, 1 M)

A cathode was prepared such that a mixing ratio of fine sulfur powder:VGCF (Vapor Grown Carbon Fiber):PvdF (Polyvinylidenefluoride) was 6:2:2 and a sulfur loading amount was 4.0 mg/cm².

A separator employed a sheet of a PE separator and a sheet of a carbon sheet (conduction structure) and was used as a reaction site of liquid PS.

As for an electrolyte, 100 ml of a typical electrolyte was injected to a lower part of a separator cell and 50 ml of the PS electrolyte was injected between the carbon sheet and the cathode.

Case 2. (PS Electrolyte Substituted for Typical Electrolyte, 0.25 M)

A cathode was prepared such that a mixing ratio of fine sulfur powder:VGCF:PvdF was 6:2:2 and a sulfur loading amount was 4.0 mg/cm².

A separator employed a sheet of a PE separator and a sheet of a carbon sheet (conduction structure) and was uses as a reaction site of liquid PS.

As for an electrolyte, 150 ml of the PS electrolyte was injected between the carbon sheet and the cathode.

Contents and Results of Experiments

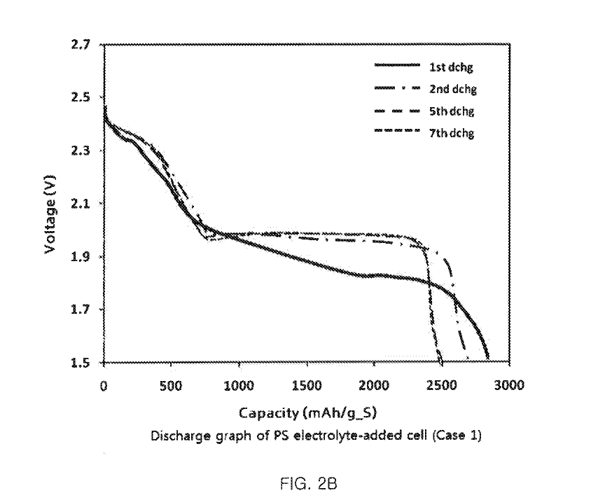

The result of the experiment of Case 1 are shown in the graphs depicted in FIGS. 2A-2B.

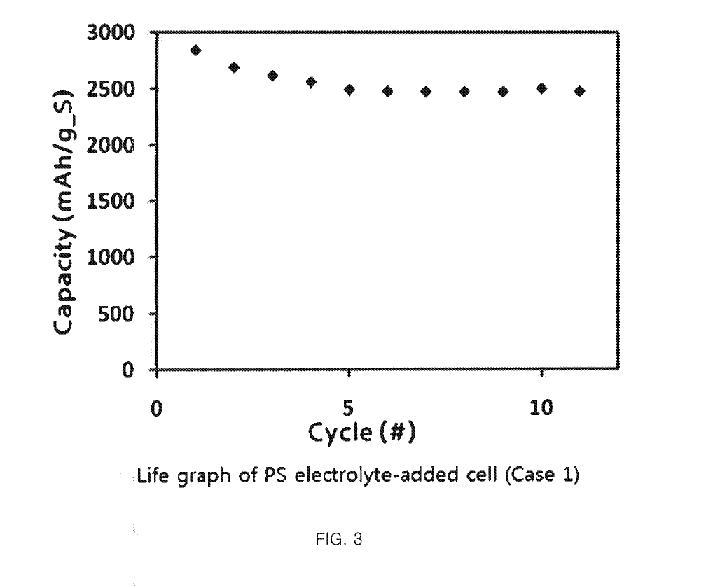

In particular, as a result of an electric charge/discharge test at a 0.01 C rate with respect to a loading amount of cathode sulfur, an initial electrical discharge capacity was expressed as about 2840 mAh/g. The cathode had its own capacity of about 1000 to 1100 mAh/g, and an additional capacity caused by the PS electrolyte was expressed as about 1700 mAh/g. Further, a curve of first round discharge did not demonstrate a stable flat voltage section, but a curve of second or further round discharge was stabilized. Further, at a cycle number of 10 or more, a reversible capacity of about 2500 mAh/g was shown. These results are shown in graph shown in FIG. 3.

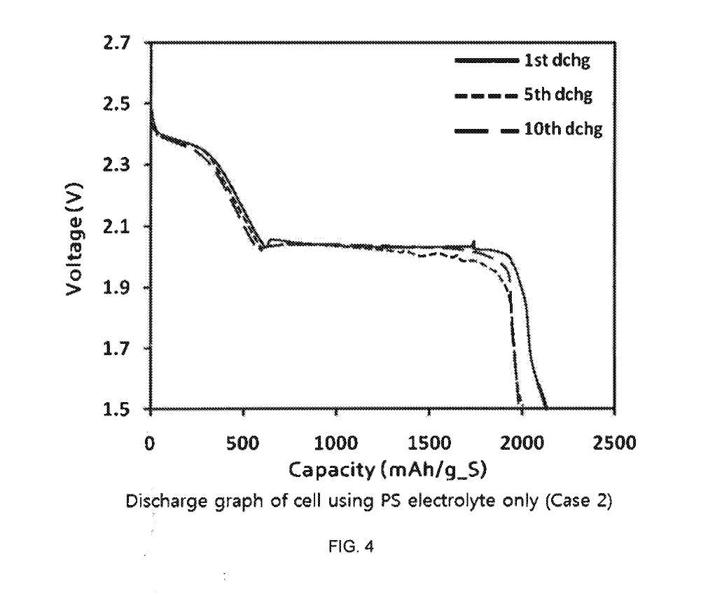

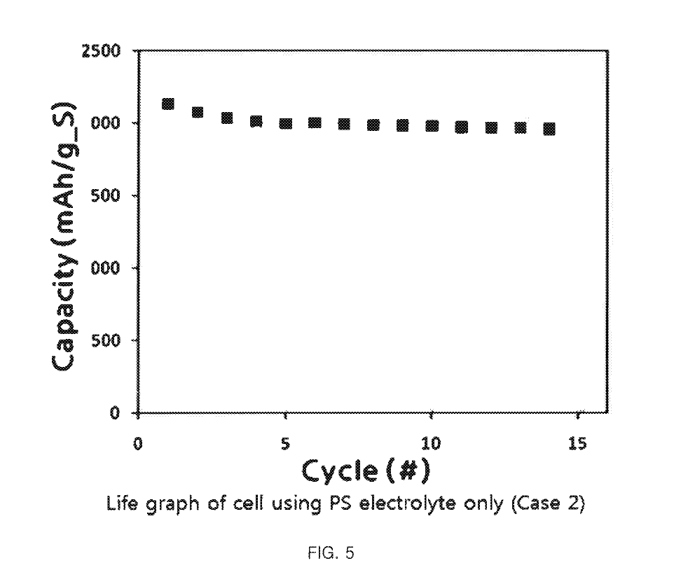

The results of the experiment of Case 2 are shown in the graphs of FIGS. 4-5.

In particular, as a result of an electric charge/discharge test at 0.01 C rate with respect to a loading amount of cathode sulfur, an initial electrical discharge capacity was expressed as about 2130 mAh/g. The cathode had its own capacity of about 1000 to 1100 mAh/g, and an additional capacity caused by the PS electrolyte was expressed as about 1100 mAh/g. At a cycle number of 10 or more, a reversible capacity of about 2000 mAh/g was shown, and a decrease in initial capacity was less than that demonstrated for Case 1. The capacity of Case 1 where the PS electrolyte was injected mainly to the carbon sheet was higher by about 600 mAh/g than the capacity of Case 2 where the PS electrolyte was injected overall (PS electrolyte=−added cell vs. PS electrolyte only). However, Case 2 is more desirable in terms of convenience of processing (i.e., manufacturing ease).

As a result, it was found that the a loading amount of cathode sulfur of the present invention can be increased to at least about 13.5 mg/cm² and structural energy density can be increased from about 265 Wh/kg to at least about 355 Wh/kg.

Although the present invention has been described only in conjunction with the described specific embodiments in detail, such embodiments are provided only for illustration and the present invention is not limited thereto. It will be apparent to one of ordinary skill in the art that various modifications and variations of the described embodiments can be made without departing from the scope of the present invention within the spirit and scope of the invention as defined by the appended claims and their equivalents.

What is claimed is:

1. A cathode for a lithium sulfur battery comprising:
a sulfur-containing active material;
an electrolyte in which a lithium salt is dissolved in an ether-based solvent; and
an additional liquid active material in the form of Li₂Sₓ (0<x≦9) dissolved in the electrolyte.

2. The cathode for a lithium sulfur battery of claim 1, wherein the additional liquid active material Li₂Sₓ (0<x≦9) in the electrolyte has a concentration of about 0 M to about 6 M.

3. The cathode for a lithium sulfur battery of claim 1, wherein the ether-based solvent is selected from Tetraethylene glycol dimethyl ether (TEGDME), 1,3-dioxolane (DIOX), or a mixture thereof, and the lithium salt dissovled therein is Lithium-Bis-Trifluoromethanesulfonyl-Imide (LiTFSI).

4. The cathode for a lithium sulfur battery of claim 3, wherein the LiTFSI has a concentration of about 0.99 M to about 1.01 M.

5. The cathode for lithium sulfur battery of claim 3, wherein a mixing ratio of the TEGDME to DIOX is about 1:1.

6. A lithium sulfur battery comprising:
a cathode of claim 1;
a separator; and
an anode containing lithium,
wherein a conduction structure is disposed between the cathode and the separator, and the conduction structure is a porous structure.

7. The lithium sulfur battery of claim 6, wherein the porous structure is a carbon sheet.
